(19) United States
(12) Patent Application Publication
(10) Pub. No.: US 2022/0053747 A1
(43) Pub. Date: Feb. 24, 2022

(54) FISHING LINE FLOAT

(71) Applicants: James Miles, Shepherdsville, KY (US); Carl Moore, JR., Shepherdsville, KY (US)

(72) Inventors: James Miles, Shepherdsville, KY (US); Carl Moore, JR., Shepherdsville, KY (US)

(21) Appl. No.: 16/996,893

(22) Filed: Aug. 19, 2020

(51) Int. Cl. A01K 93/00

(52) U.S. Cl. CPC A01K 93/00

(57) ABSTRACT

An illustrated view of an exemplary float for fishing is presented. The float is useful for keeping a hook on a fishing line at a depth below a water line of a body of water. The float provides an easily visible, consistent depth for the hook on the fishing line. The float preferably has a shape of a bullet or a mortar. The float has a tail fin that is preferably orange in color. The tail fin is coupled to a casing, the casing preferably being gold in color. A tip that has a first portion and a second portion where the second portion may be a light. A first end of the tip is coupled to the casing and the second end is pointed and is coupled to an eyelet.

### FIELD OF THE INVENTION

This invention relates to fishing tackle. More particularly, it relates to floats for fishing.

### BACKGROUND

Fishing is the activity of trying to catch fish. Fish are normally caught in the wild. Techniques include hand gathering, spearing, netting, angling and trapping. “Fishing” may include catching aquatic animals other than fish, such as mollusks, cephalopods, crustaceans, and echinoderms. The term is not normally applied to catching farmed fish, or to aquatic mammals, such as whales where the term whaling is more appropriate. In addition to being caught to be eaten, fish are caught as recreational pastimes. Fishing tournaments are held, and caught fish are sometimes kept as preserved or living trophies. When BioBlitz's occur, fish are typically caught, identified, and then released.

Artisanal fishers use traditional, low-tech methods, for survival in third-world countries, and as a cultural heritage in other countries. Usually, recreational fishers use angling methods and commercial fishers use netting methods.

Why a fish bites a baited hook or lure involves a number of factors related to the sensory physiology, behavior, feeding ecology, and biology of the fish as well as the environment and characteristics of the bait/hook/lure. There is an intricate link between various fishing techniques and knowledge about the fish and their behavior including migration, foraging and habitat. The effective use of fishing techniques often depends on this additional knowledge. Some fishermen follow fishing folklores which claim that fish feeding patterns are influenced by the position of the sun and the moon.

Fishing tackle is the equipment used by fishermen when fishing. Almost any equipment or gear used for fishing can be called fishing tackle. Some examples are hooks, lines, sinkers, floats, rods, reels, baits, lures, spears, nets, gaffs, traps, wad ers and tackle boxes.

Tackle that is attached to the end of a fishing line is called terminal tackle. This includes hooks, sinkers, floats, leaders, swivels, split rings and wire, snaps, beads, spoons, blades, spinners and devises to attach spinner blades to fishing lures. People also tend to used dead or live fish as another form of bait.

Fishing tackle refers to the physical equipment that is used when fishing, whereas fishing techniques refers to the ways the tackle is used when fishing.

Floats are used to position a hook at a particular determined depth in the water. The hook is floated above the bottom of the water to create action in the lure being used and to place the hook in a depth that the fish are currently active. Floats are sometimes hard to see and do not allow the hook and bait to stay at a determined depth.

In light of the foregoing, there is a need for a float for fishing that is easy to see and to keep the hook and bait in a pre-determined depth of the water.

### BRIEF DESCRIPTION OF THE DRAWINGS

FIG. 1 is an illustrated view of an exemplary float for fishing.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

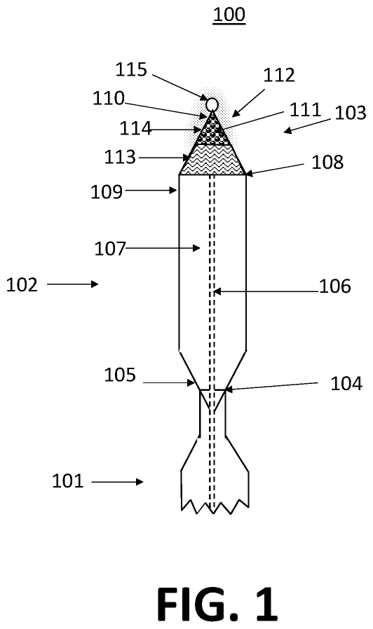

Referring to FIG. 1, an illustrated view of an exemplary float 100 for fishing is presented. The float 100 is useful for keeping a hook on a fishing line at a depth below a water line of a body of water. The float 100 provides an easily visible, consistent depth for the hook on the fishing line. The float 100 preferably has a shape of a bullet or a mortar.

The float 100 is preferably eighteen (18) inches in length, but other lengths are hereby contemplated, including, but not limited to, twelve (12) inches, nineteen (19) inches, etc. The float 100 is preferably sixty (60) millimeters (mm) in width, but other widths are hereby contemplated, including, but not limited to, twenty-five (25) mm, twenty (20) mm, fifty (50) caliber, etc. The float 100 is preferably made of a Styrofoam material, but other materials are hereby contemplated, including, but not limited to, balsa, plastic, poly-vinyl chloride (PVC), etc.

The float 100 has a tail fin 101, a casing 102 and a tip 103. The tail fin 101 of the float 100 is preferably a fin shape, but other shapes are hereby contemplated, including, but not limited to, squid shape, round, etc. The tail fin 101 is preferably made of a plastic material, but other materials are hereby contemplated, including, but not limited to, balsa, plastic, poly-vinyl chloride (PVC), etc. The tail fin 101 preferably has a color of orange, but other colors are hereby contemplated, including, but not limited to, yellow, blue, pink, etc.

A first end 104 of the tail fin 101 of the float 100 is coupled to a first end 105 of the casing 102. The casing is preferably bullet shape, but other shapes are hereby contemplated, including, but not limited to, mortar, round, cylindrical, etc. The float 100 also has an opening 106 through a middle portion 107 of the float 100. The casing 102 preferably has a color of gold, but other colors are hereby contemplated, including, but not limited to, silver, copper, etc.

A first end 108 of the tip 103 is coupled to a second end 109 of the casing 102. The tip 103 has a point at the second end 110 of the tip 103 of the float. An eyelet 115 is securely coupled to substantially near the second end 110 of the tip 103 of the float 100. The second end 110 of the tip 103 may optionally have a light 111. The light 111 may emit a glow 112. The light 111 provides an easy method to visibly find the float 100 when it is dark, gloomy, foggy, in brush, etc. The light 111 is preferably a light emitting diode (LED) lamp, but other types of lamps are hereby contemplated, including, but not limited to, liquid crystal display (LCD), fluorescent, etc.

A first portion 113 of the tip 103 is preferably an orange color, but other colors are hereby contemplated, including, but not limited to, yellow, blue, pink, etc. A second portion 114 of the tip 103 is preferably a yellow color, but other colors are hereby contemplated, including, but not limited to, blue, red, orange, etc. The light 111 being configured in the second portion 114 of the tip 103 of the float 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A float for setting a fishing line to a determined depth, the float comprising:
a tail fin, the tail fin having a first end;
a casing, the casing having a first end and a second end, wherein the first end of the tail fin being coupled to the first end of the casing;
a tip, the tip having a first portion, a second portion, a first end and a second end, wherein the second end of the tip being removably coupled to the second end of the casing;
an eyelet, the eyelet being securely coupled to the second end of the tip; and
an opening, the opening being for threading the fishing line to secure the float to the fishing line at a determined depth, and wherein the opening being through a middle portion of the float.

2. The float of claim 1, wherein the float having a length of eighteen (18) inches.

3. The float of claim 1, wherein the float having a width of sixty millimeters (60 mm).

4. The float of claim 1, wherein the float being a bullet shape.

5. The float of claim 1, wherein the float being a mortar shape.

6. The float of claim 1, wherein the float being made of a Styrofoam material.

7. The float of claim 1, wherein the tail fin being made of a plastic material.

8. The float of claim 1, wherein the second portion of the tip being a light.

9. The float of claim 8, wherein the light being a light emitting diode (LED).

10. The float of claim 1, wherein first portion of the tip being orange in color.

11. The float of claim 1, wherein the casing being a gold color.

12. The float of claim 1, wherein the tail fin being an orange color.

13. The float of claim 1, wherein the casing being a bullet shape.

14. The float of claim 1, wherein the second portion of the tip being yellow in color.

15. The float of claim 1, wherein the second portion of the tip being a point.
